(19) United States
(12) Patent Application Publication
(10) Pub. No.: US 2025/0146611 A1
(43) Pub. Date: May 8, 2025

(54) Smart Scale Locator

(71) Applicant: Saudi Arabian Oil Company, Dhahran (SA)

(72) Inventors: Abdulhakeem Almufadhi, Al Hofuf (SA); Ahmad A. Alhumeni, Al Hofuf (SA)

(21) Appl. No.: 18/502,790

(22) Filed: Nov. 6, 2023

(51) Int. Cl. F16L 55/48; F16L 55/40; F16L 101/30

(52) U.S. Cl. CPC F16L 55/48; F16L 55/40; F16L 2101/30

(57) ABSTRACT

A system for locating a scale deposit in a pipeline includes a locator device and a computer sub-system operably connected to the device. The device includes at least one protrusion attached to a hollow, housing. The housing has an interior cavity, an exterior surface defining at least one slot, and at least one recess. The device also includes an electronic sub-system arranged in the interior cavity of the housing. The electronic sub-system includes a global position system (GPS) module operable to determine a geolocation of the device. The computer sub-system is operable to determine a location of a scale deposit in a pipeline based on a received geolocation of the device.

### TECHNICAL FIELD

This disclosure relates to devices, systems, and methods, for detecting scale deposits in a pipeline, and more particularly to inline devices, systems, and methods for locating scale deposits in a pipeline.

### BACKGROUND

Oilfield scale deposits can consist of inorganic deposits along with some organic deposits (wax deposition, hydrate formation, asphaltine deposition) or corrosion deposits and can be found in many locations, such as pipe walls, valves, downhole equipment and pump. Chemically, scale deposition is the crystalline precipitate of mineral compounds formed in water. In the presence of wax, oil, gas or corrosion products in pipelines, the formed scale would contain more than one mineral because of the trapped wax and iron oxide during the scale formation. Scale can occur due to a change of various physical properties of fluid (usually water) such as pressure, temperature and pH, or due to incompatible fluid mixing. In oil and gas industry, common scale compositions can include carbonates (calcium carbonate, siderite), sulfates (barium sulfate and calcium sulfate) and halites. Scale solids (crystals) can present in pipeline, for example, by suspending in aqueous solution or adhering to the pipe surface. Growth of the scale crystal can cause formation plugging, increase wall roughness, and reduce production rates.

Scale removal systems can include chemical solvents, mechanical wire brushing, milling, and explosive or jet blaster tools. Scale detectors and identifiers can include offline techniques, like electrochemical analysis of brine solutions, and inline techniques, like static scale sensors, ultrasound detectors, gamma-ray detectors, Magnetic Flux Leakage (MFL) sensors. In addition, some systems use Pipeline Inspecting Gauges (PIGs) to detect, identify, and remove scale. Additional methods for locating the formed scale involves cutting the pipeline at several points along the pipeline to locate the deposit.

### SUMMARY

In certain aspects, a system includes a locator device and a computer sub-system operably connected to the device. The device has a hollow, housing with an interior cavity, an exterior surface defining at least one slot, and at least one recess extending from the at least one slot of the exterior surface of the housing, towards the interior cavity of the housing. The housing also includes an electronic sub-system arranged in the interior cavity of the housing. The electronic sub-system includes a global position system (GPS) module operable to determine a geolocation of the device and a transceiver operable to send and receive signals. The device also includes at least one protrusion attached to the housing. The at least one protrusion has a coupling at a first end of the protrusion and a body. The coupling, at a first end of the protrusion, is arranged in the recess of the housing. The body has a tip at a second end of the protrusion. The computer sub-system includes a controller and one or more processors, a non-transitory computer-readable medium storing instructions executable by the one or more processors to perform operations. The operations include determining a location of a scale deposit in a pipeline based on a received geolocation of the device.

Some housings also include a first portion with a first well and a second portion having a second well, wherein the first and second well define the interior cavity. The first portion includes a first material and the second portion comprises a second material. The housing can have coupling walls defining the recess. The coupling walls may releasably attach the at least one protrusion to the housing of the device.

In some systems, the housing is a spherical housing, e.g., with a housing diameter of about 0.1 inch to about 4 inches. The device can have a diameter of about 1 to about 10 inches and can be made of a non-metallic material.

The protrusion can be releasably attached to the housing.

In some embodiments, the body of the protrusion is configured to fasten the device to a scale deposit in a pipeline.

Some bodies of the protrusion is a cutting blade having a cutting edge.

In some cases, the body of the protrusion is a serrated blade has a serrated cutting edge.

In some embodiments, the body of the protrusion comprises multiple barbs.

The body of the protrusion can define an opening.

In some systems, coupling of the protrusion comprises arms engageable with walls of the housing to hold the coupling of the protrusion in the recess of the housing.

In some embodiments, the body at least partially extends from the exterior surface of the housing. The length of the body can extend from the exterior surface of the housing.

In certain aspects, a method includes fastening to a scale deposit in a pipeline by a body of a protrusion of a device moving within the pipeline, determining, by a GPS module of the device, a geolocation of the device, and transmitting, by a transceiver of the device, the geolocation of the device to a remote computer sub-system.

In some embodiments, fastening to the scale deposit in the pipeline includes impaling the scale deposit with a blade of the body.

In some methods, fastening to the scale deposit in the pipeline includes catching onto a surface of the scale deposit by a face of the body. The face of the body can be serrated, barbed, spiked and/or spined.

In some embodiments, transmitting, by the transceiver of the device, the geolocation of the device to the remote computer sub-system includes determining, by a pressure sensor of the protrusion, a pressure from contact between the body and the scale forming the scale deposit, and in response to the pressure, activating the GPS module.

In some methods, the geolocation is a static geolocation, and wherein the method includes, prior to fastening to the scale deposit, determining, by a GPS module in the device, a variable geolocation of the device and transmitting, by the transceiver of the device, the variable geolocation of the device to the remote computer sub-system.

In certain aspects, a method includes receiving a first set of geolocation data from a device in a pipeline, receiving a second set of geolocation data from the device in the pipeline, determining if the device is static in the pipeline based on at least the first set of geolocation data and the second set of geolocation data, and, in response to determining the device is static, determining static coordinates of the device based on at least the second set of data.

In some methods, the coordinates contain a longitude and a latitude.

Some methods also include generating an alert on a display of the computer sub-system or connected to the computer sub-system, wherein the alert displays the static coordinates of the device in the pipeline.

Some methods also include prior to receiving the first set of data, receiving measurement parameter of a pipeline determining that the parameter suggests scale formation in a portion of the pipeline. The parameter may be at least one of a pipeline pressure and a flow rate of fluid in the pipeline.

In certain aspects, a locator or locator device includes a hollow housing having a housing diameter. The housing includes an interior cavity, an exterior surface defining at least one slot, and at least one recess extending from the at least one slot of the exterior surface of the housing, towards the interior cavity of the housing. The device also includes an electronic sub-system arranged in the interior cavity of the housing. The electronic sub-system includes a global position system (GPS) module operable to determine a geolocation of the device and a transceiver operable to send and receive the geolocation of the device. The device has at least one protrusion releasably attached to the housing. The at least one protrusion includes a coupling at a first end of the protrusion, wherein the coupling is arranged in the recess of the housing, and a body having a tip at a second end of the protrusion. The body is configured to fasten the device to a scale deposit in a pipeline.

The devices, systems, and methods, described herein can quickly locate the heart of start of a scale deposit and transmit the location of the scale deposit to various connected systems and/or operators. The systems, devices, and methods, may reduce the required time to identify the scale location, reduced labor force required to locate the scale deposit, and/or reduce the cost of locating the scale deposit in a pipeline. The systems, devices, and methods also may locate scale deposits with increased accuracy and precision, thereby reducing or eliminating the need to cut into the pipeline in search of a scale deposit. Reducing or eliminating the amount of times a pipeline is cut can reduce costs and labor associated with both cuts cut repairs, and can reduces the risk of mechanical pipe failure as each cut and/or repair negatively impacts the structural integrity of a pipe.

Quickly obtaining or determining the location of a scale deposit can prevent additional scale buildup and increase the efficacy of a scale removal techniques due to a smaller buildup amount. The systems and devices can be simple to operate, require little training, and have a reduced number of components. The systems and devices may take up a small volume of the pipeline interior and thus can be used during production operations.

Protrusions of the devices can be removable customizable so that the devices can be altered to fit a variety of pipelines and engage a variety of scale types. In addition, the protrusions can be chosen to prevent or reduce mechanical damage to the inner surface of the pipeline. The systems and devices can include multiple sets of connectable protrusions so that a single device or system can be reused in subsequent pipelines. In addition, the systems and devices can be sized or shaped with flow through channels so that, when engaged with scale, the device does not seal off the fluid path of the fluid flowing in the pipeline. The systems and devices can therefore be used with a variety of operational stages in a pipeline, for example, production stages, cleaning stages, pre-cleaning stages, post-cleaning stages, and testing or calibration stages.

The details of one or more embodiments are set forth in the accompanying drawings and the description below. Other features, objects, and advantages will be apparent from the description and drawings, and from the claims.

### DESCRIPTION OF DRAWINGS

FIG. 1 is a front view of a system for locating a scale deposit in a pipeline.

FIG. 2 is a perspective view of a device of the system in FIG. 1.

FIG. 3 is a cross sectional front view of the device in FIG. 2.

FIG. 4A is a perspective view of a first portion of the device in FIG. 2.

FIG. 4B is a perspective view of a second portion of the device in FIG. 2.

FIG. 4C is a perspective view of an electronic arrangement of the device in FIG. 2.

FIG. 4D is a perspective view of a protrusion of the device in FIG. 2.

FIGS. 5A and 5B are cross sectional front view of the system locating a scale deposit in a pipeline.

FIG. 6 is a decision flowchart of a method for locating a scale deposit in a pipeline using a system with a locator device and a remote computer sub-system.

FIGS. 7A-7F are front views of a variety of protrusions insertable into the first and/or second portions of a device.

FIGS. 8A-8E are front views of protrusions with a variety of connections for attaching the protrusion to the first and/or second portion of a device.

FIG. 9 is a perspective front view of a device with a housing having a permeable shell encompassing a protective casing of the device.

FIG. 10 is a perspective front view of a system with a set of devices having different diameters and permanent blades.

FIGS. 11A and 11B are perspective views of a device with retractable protrusions.

Like reference symbols in the various drawings indicate like elements.

### DETAILED DESCRIPTION

The present disclosure relates to a system, device, and method for locating a scale deposit. The system includes the device and a computing sub-system connected to the device. The device has a GPS module operable to determine a global position or location of the device when the device is inserted or deployed in a pipeline. The device also includes barbs or protrusions projecting from a housing. The protrusions catch, impale, or otherwise fasten the device to a deposit of scale into the pipeline. The device determines and transmits its geolocation at regular intervals to the computer sub-system. When the protrusion fastens to a scale deposit, the geolocation is static for at least two intervals. The computing sub-system analyzes the transmitted data to determine whether the device is static and, if the device is static, the location of a scale deposit within the pipeline.

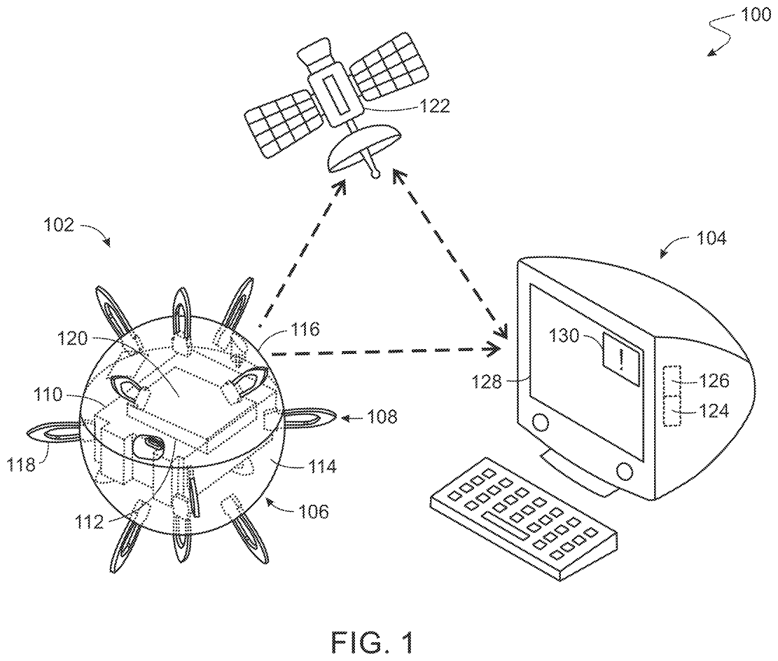

FIG. 1 is a front view of a system 100 for locating a scale deposit in a pipeline. The system 100 includes a locator device 102 and a computer sub-system 104. The locator device 102 (e.g., locator, tracker device, scale detection device, scale detector) periodically determines or is operable to periodically determine a geolocation of the locator device 102 and transmits or is operable to transmit the location to an operator or connected remote system. The locator device 102 transmits a geolocation in the form of a global coordinate (e.g., a longitude and/or latitude) or in a data packet from which global coordinates can be determined. In some devices, the transmitted geolocation corresponds to an initial geoposition (e.g., an insertion location or insertion coordinates), a measured distance, velocity, or acceleration, a directional parameter, and/or a time parameter.

The locator device 102 includes a hollow, spherical housing 106, a set of protrusions 108 (e.g., multiple protrusions, a plurality of protrusions), and an electronic sub-system 110. The housing 106 defines an interior cavity 112 encased by the housing 106. The electronic sub-system 110 is arranged in the cavity and fixed to walls 115 of the cavity so that the housing 106 forms a protective casing around the electronic sub-system 110. The cavity may be a pressurized cavity configured to withstand pipeline pressures and temperatures. For example, the cavity may withstand pressure of about 0 to about 3000 psi and temperatures of about 65.5 to about 90 C. In addition, the cavity 112 is fluidically isolated from the environment outside the housing 106 (e.g., a pipeline environment). In this configuration, the electronic sub-system 110 is protected from high or low pipeline pressures and temperatures and is fluidically sealed from fluid flowing in the pipeline.

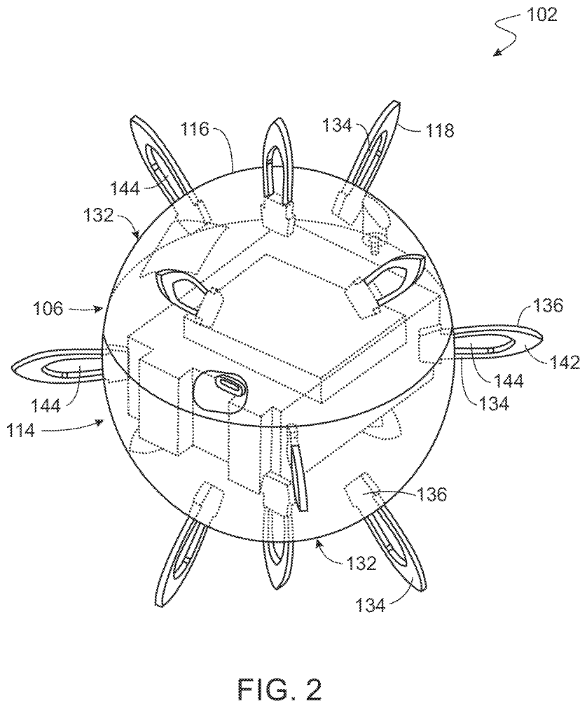

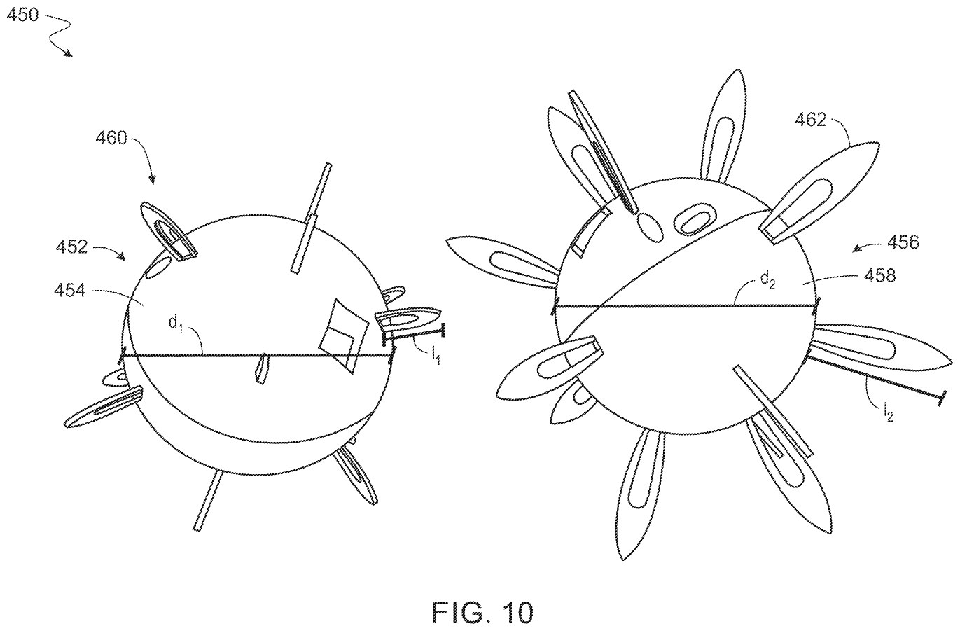

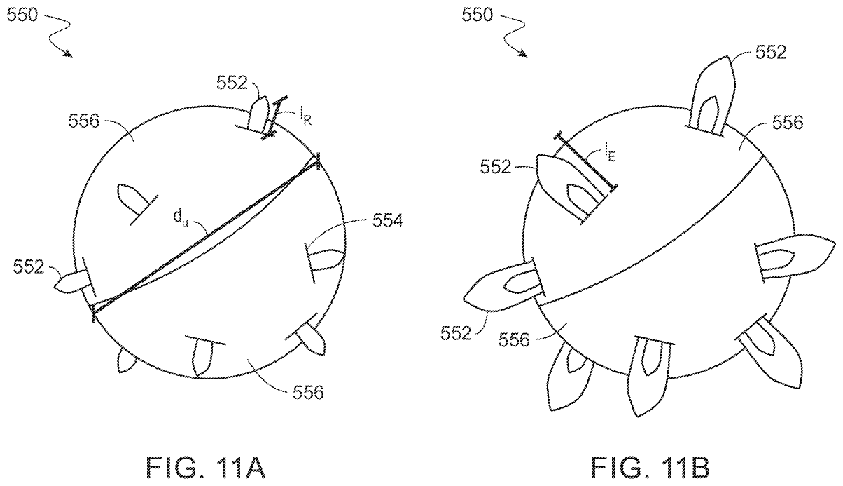

The housing 106 includes a first portion 114 and a second portion 116. The first and second portions 114, 116 attach to form the housing 106 with the interior cavity 112. The first and second portions 114, 116 are connected to form a sealed housing 106 around the cavity 112. First and second portions may be connected by magnets, a threaded connection, a snap fit connection, and/or an antenna coupling. The set of protrusions 108 includes individual, uniform protrusions 118 (e.g., at least one protrusion) attached to the housing 106. The uniform protrusions 118 are configured to impale, fasten, stab, grip, and/or mechanically engage a scale deposit in a pipeline. The set of protrusions may be releasably (e.g., removably) attached to the housing and/or permanently fixed to the housing. Devices with releasably attached protrusions are described with reference to FIGS. 2-5B and 7A-8B. Devices with permanently fixed (e.g., permanently attached) or integral protrusions are described with reference to FIGS. 10-11B.

The electronic sub-system 110 of the device 102 is operably connected to the computer sub-system 104 at a surface and/or remote location. The electronic sub-system 110 includes a Global Positioning System (GPS) module 120 that is operably connected to at least satellite 122 (e.g., one, two, three, four, or five satellites). The GPS module is operable to determine a geolocation of the device 102 based on signals received from the at least one satellite 122. The electronic sub-system 110 is also operable to transmit the geolocation of the device 102 to the computer sub-system 104 of the system 100.

The computer sub-system 104 of the system 100 is operably connected to the electronic sub-system 110 of the device 102. In some systems, the computer sub-system is operably connected to the at least one satellite. In some systems, the computer sub-system is operably connected to both the electronic sub-system of the device and the at least one satellite. The computer sub-system 104 includes a controller 124, one or more processors 126, and a non-transitory computer-readable medium storing instructions executable by the one or more processors 126 to perform operations. The operations include determining a location of a scale deposit or static geolocation in a pipeline based on a received geolocation transmitted by the device 102. The received geolocation may be a set of global coordinates (e.g., a longitude and/or latitude) and/or may be a geolocation data packet. The geolocation data packet can be processed by the processor to determine global coordinates (e.g., the longitude and/or latitude) and/or location of the device in the pipeline.

The computer sub-system 104 also includes a display 128. The controller 124 and/or processor 126 prompts the display 128 to project a visual alert 130, notifying the operator of a static location, geolocation, and/or coordinates of the device 102 in a pipeline. The alert may also display or identify a location of a scale deposit that corresponds to the static location of the device. The alert 130 is a visual alert on an integrated display 128 of the computer sub-system, however, the alert may be generated on a portable screen or display of the computer sub-system or a portable screen, portable display, or remote display connected to the computer sub-system.

FIG. 2 is a perspective view of the device 102 with releasably attached protrusions 118. The housing 106 of the device is a spherical housing 106 with an exterior surface 132 and a diameter dh. The diameter dh of the housing is about 0.1 to about 4. In some devices, the housing diameter is about 1 inch to about 3 inches.

The first portion 114 includes or is made of a first material. The second portion 116 includes or is made of a second material. In the system 100, the first material and second material are the same material. The first and second material is a non-metallic material. In some devices, the first and/or second material can be carbon steel, stainless steel, fiber glass, or any combination thereof.

In some systems, the first and second material may be different materials. The first and second materials may be the same material but have enhancements or features that alter parameters of the material. For example, the first material may have a hydrophobic coating or may be embedded with a scale inhibitor. In some housings, the first material is denser than the second material. In some devices, the second material is denser than the first material. In some devices, the first and second materials have the same density. In some devices, the first material is more buoyant than the second material. In some cases, the second material is more buoyant than the first material. In some devices the first and second materials have about equal buoyancies.

In some devices, the first portion is more buoyant than the second portion. In some cases, the second portion is more buoyant than the first portion. In some devices the first and second portions have about equal buoyancies. In some housings, the first and/or second portions of the housing may have a weighted section containing a third material having a density or weight greater than the density or weight of the first and/or second portion. The weighted section can orient the device so that, when the device is arranged in a fluid, the weighted section is submerged, partially submerged, or adjacent to the fluid.

Each protrusion 118 has a (first) connection end 134 and a (second) free tapered end 136. The connection end 134 is inserted or arranged into the housing 106 to connect the protrusion 118 to the housing 106. Each protrusion 118 includes a protrusion coupling (e.g., a blade coupling, a coupling structure) 138 at the connection end 134. The protrusion coupling is configured to engage the housing 106 so that the protrusion 118 and the housing 106 are releasably connected. The protrusion 118 also includes a body 140 extending from the coupling 138 to a tip 142 at the free end 136. At least a part of the body 140 extends from the exterior surface 132 of the housing and is configured to engage with a deposit to fasten the device 102 to the deposit in a pipeline. The body 140 also defines an opening 144. Fluid can flow through the opening 144. The opening may enhance the grip or connection of the body to the deposit when the body is engaged or fastened to a deposit.

The protrusions 118 have a hardness greater than the scale deposit of interest, for example a hardness greater than about 3 or about 3 on the Mohs hardness scale. The uniform protrusions 118 includes or is made of a third material. In the system 100, the third material is different from the first and second. The third material a non-metallic material. In some devices, the third material can be carbon steel, stainless steel, fiber glass, or any combination thereof. The protrusions 118 extend a length lp (protrusion length) from the housing 106 when the protrusions 118 are attached to the housing 106. In this configuration, the device 102 has a device diameter dd that is equal to the diameter of the housing dh and two times the length lp of the protrusion 118. The length lp of the protrusions is 1.5 to about 3 inches. In some devices, the protrusion length is about 1 to about 4 inches.

In some devices, the diameter dd is about 1 inch to about 10 inches.

The protrusion may be selected based on the type of scale deposit anticipated by the computer sub-system or an operator, based on measured conditions of the well. For example, if a softer scale deposit is anticipated (e.g., a wax deposit), protrusions with a hardness between about 10 and about 3 on the Mohs scale of mineral hardness and may be attached to the housing. If a harder scale deposit is anticipated (e.g., calcium carbonate deposit a protrusion with a hardness of at least 4 on the Mohs hardness scale, for example, at least about 4.5, at least about 5, at least about 6, between about 4 and about 10, about 5 to about 10, about 6 to about 10, about 7 to about 10, about 4 to about 9, about 5 to about 9, about 6 to about 9, about 5 to about 8, about 7 to about 9, or about 6 to about 8, may be attached to the housing.

The protrusion may also selected based on a known or calculated diameter of the pipeline. For example, the protrusion may be selected so that the device diameter (e.g., the sum of the housing diameter and double the length l of the protrusion) is less than the diameter of the pipeline. The protrusion may be selected so that the device diameter is proportional to the pipeline diameter (e.g., less than about 90% of the pipeline diameter, less than about 80% of the pipeline diameter, less than about 70% of the pipeline diameter, less than about 60% of the pipeline diameter, less than about 50% of the pipeline diameter, less than about 40% of the pipeline diameter, less than about 30% of the pipeline diameter, less than about 20% of the pipeline diameter, or about 10%, about 2%, about 3%, about 4%, about 5%, about 6%, about 7%, about 8%, about 9%, about 10%, about 15%, about 20%, about 25%, about 30%, about 33%, about 35%, about 40%, about 45%, about 50%, about 55%, about 60%, about 65%, about 66%, about 70%, about 75%, about 80%, about 85%, about 90%, or about 95% of the pipeline diameter).

In some systems, the third material is the same material as the first and/or second material. The first, second, and/or third materials may be the same material but have enhancements or features that alter parameters of the material. For example, the third material may have a adhesive coating to adhere the protrusion to a scale deposit, may be magnetized, or may be embedded with a scale softener. In some devices, the third material is denser than the first and/or second material. In some devices, the first and/or second material is denser than the third material. In some devices, the first, second, and third materials have the same density. In some devices, the third material is more buoyant than the first and/or second material. In some cases, the first and/or second material is more buoyant than the third material. In some devices the first, second, and/or third materials have about equal buoyancies.

In some sets of protrusions, the protrusions have a weighted sections containing a fourth material having a density or weight greater than the density or weight of the third material. The weighted section can orient the device so that, when the device is arranged in a fluid, the weighted section is submerged, partially submerged, or adjacent to the fluid. In some cases, the device includes at least one non-uniform, weighted protrusion and a set of uniform protrusions. The weighted protrusion is heavier than the uniform protrusions.

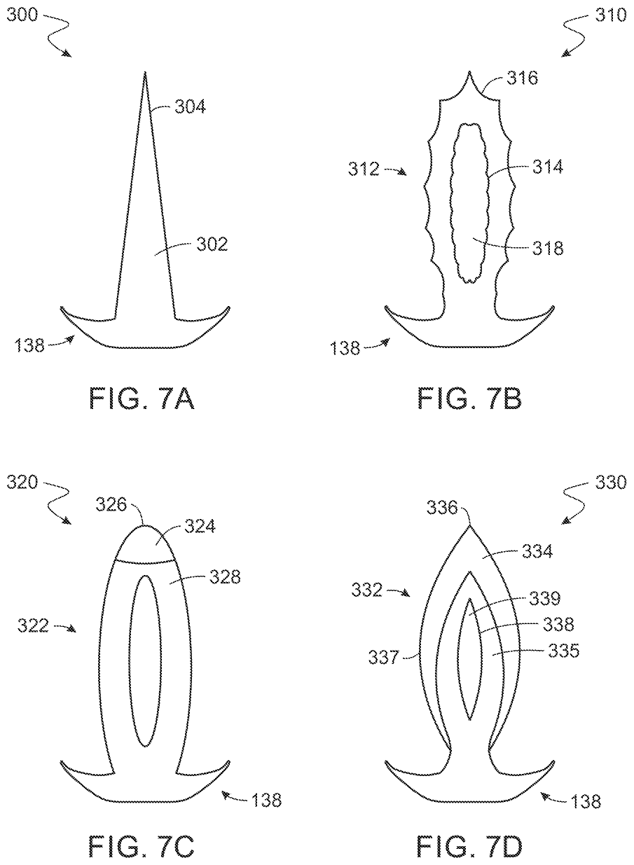

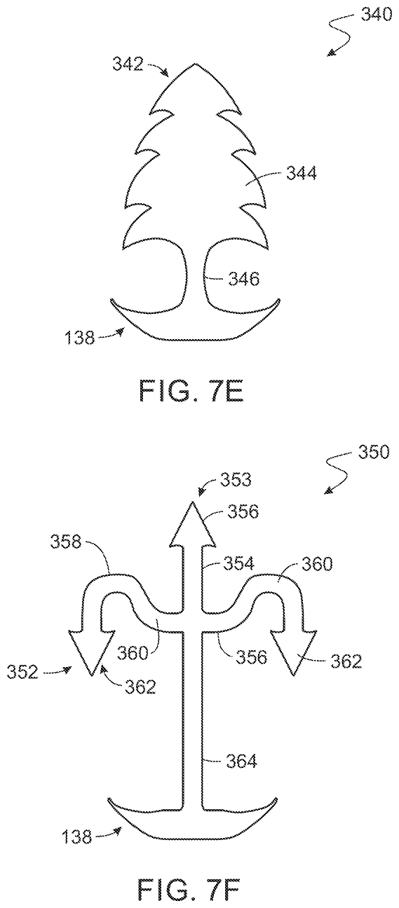

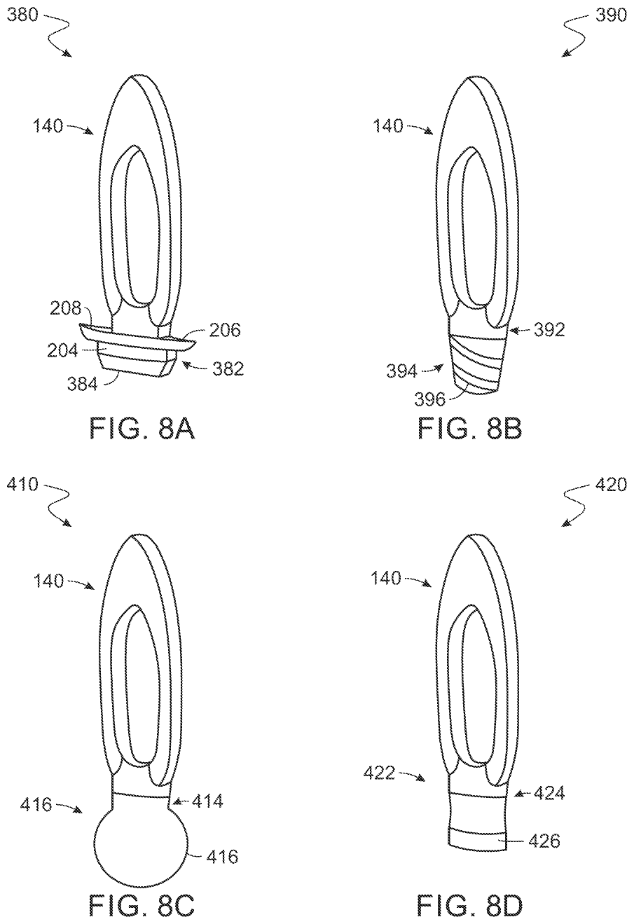

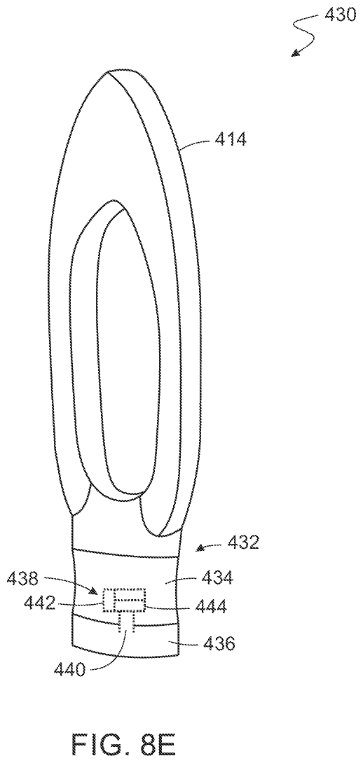

While the protrusions 118 in the set of protrusions 108 have been described as uniform, some sets of protrusions have at least one protrusion that is of a different size, material, or shape that at least one other protrusion. Variation of protrusion size, shape, and material is described with further reference to FIGS. 7A-8E.

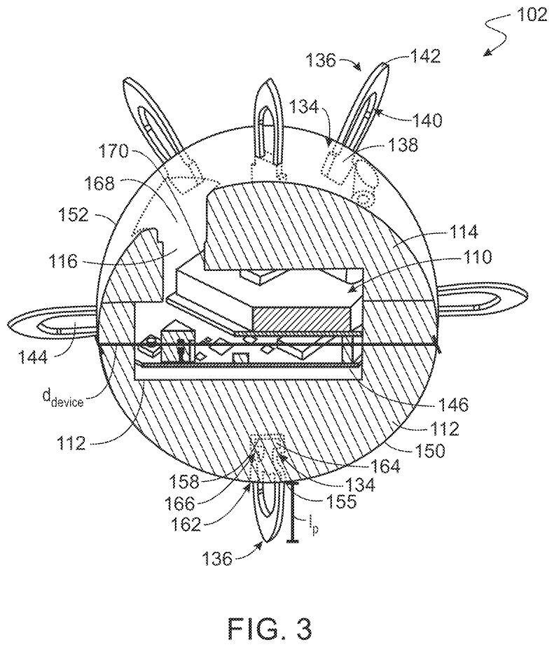

FIG. 3 is a perspective, cross-sectional view of the device 102 of the system 100. The first portion 114 of the housing 106 defines a first inner well 146. The second portion 116 of the housing 106 defines a second inner well 148. When the first portion 114 and second portion 116 of the housing 106 are attached, the first and second inner wells 146, 148 defines the interior cavity 112 in which the electronic sub-system 110 is arranged. The first portion 114 of the housing 106 also has first outer face 150 and the second portion 116 of the housing 106 has a second outer face 152. When the first and second portions 114, 116 of the housing 106 are attached, the first and second outer faces 150, 152 form the exterior surface 132 of the housing 106.

The exterior surface 132 of the housing 106 define a plurality of slots 154 (e.g., multiple slots, slots) which includes uniform, individual slots 155 (e.g., at least one slot). The housing 106 also defines a plurality of recesses 156 which include individual, uniform recesses 158 (e.g., at least one recess). Each of the slots 155 in the plurality of slots 155 align with a corresponding recess 158 in the plurality of recesses 156. The recesses 158 extend from an open end 162 at the slot 155 at the exterior surface 132 to a closed end 164. The closed end 164 of a recess 156 is closer to the interior cavity 112 as compared to the open end 162 of the recess 156. Each of the recesses 158 is defined by walls 160 of the housing 106. The walls 160 include a housing coupling 166 (e.g., coupling walls) configured or sized to couple, attach, or engage the protrusion coupling 134. The coupling may define or partially define the recess.

The second housing 116 defines an aperture 167 extending from an access port 168 defined in the second outer face 152 of the second portion 116 to a cavity inlet 170 at the interior cavity 112. A valve or removable seal may be arranged in the aperture 167, access port 168, or cavity inlet 170 to fluidically isolate the cavity 112 from the environment. The seal or valve may isolate the pressure and/or temperature in the interior cavity from the temperature and/or pressure of the environment outside the housing and/or cavity.

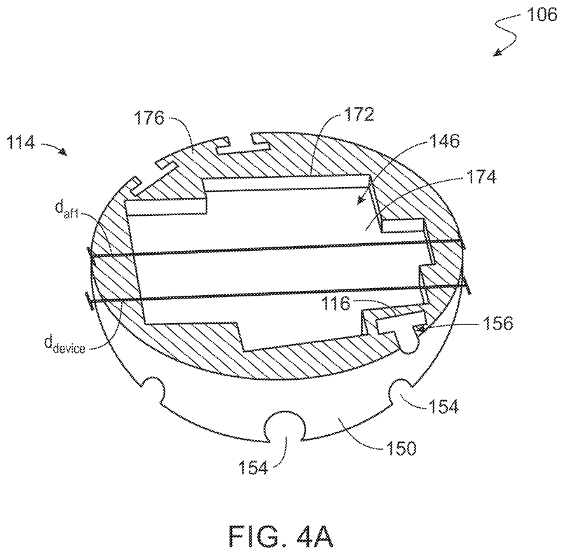

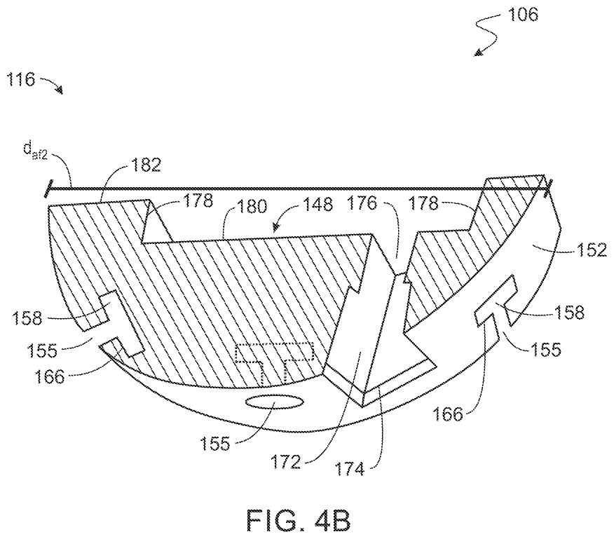

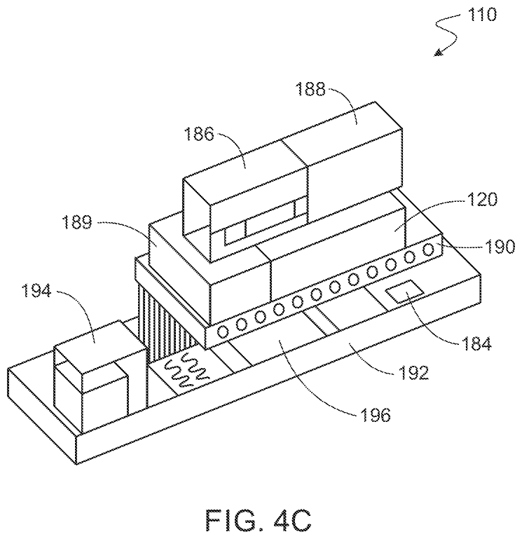

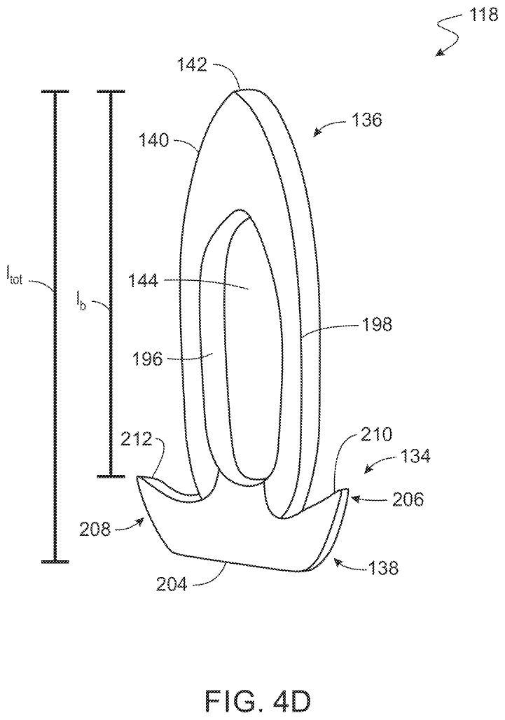

FIG. 4A is a perspective top view of the first portion 114 of the housing 106. The first well 146 is defined by edge walls 172 and a well face 174. The first well 146 is a depression in an attachment face 176 of the first portion 114. The first attachment face 176 has a diameter daf1 (first attachment diameter). The first attachment diameter daf1 is less than the diameter of the housing dh. In some cases, the first attachment diameter is greater than or equal to the diameter of the housing.

FIG. 4B is a perspective bottom view of the second portion 114 of the housing 106. The second well 148 is defined by edge walls 178 and a well face 180. The second well 148 is a depression in an attachment face 182 of the second portion 116. The cavity inlet 170 is defined in the well face 180 of the second portion 114 of the housing 106. In some second portions of the housing, the cavity inlet is defined in an edge wall of the second well. The second attachment face 182 has a diameter daf2 (second attachment diameter). The second attachment diameter daf2 is less than the diameter of the housing dh. The second attachment diameter daf2 is equal to the first attachment diameter of the first attachment face 174 of the first portion 114 of the housing 106.

In some cases, the second attachment diameter is greater than or equal to the diameter of the housing. In some cases, the first attachment diameter is less than or greater than the second attachment diameter.

FIG. 4C is a perspective view of an electronic sub-system 110 of the device 102. The electronic sub-system 110 includes the global position system (GPS) module 120 and a transceiver 184 operable to transmit and receive signals. The transceiver can be operably connected to the at least one satellite 122 (FIG. 1) and/or operably connected to the computer sub-system 104 (FIG. 1). The GPS module 120 is operable to determine a geolocation of the device 102.

The electronic sub-system 110 also includes a controller (e.g., a microcontroller) 186, one or more processors 188, and a non-transitory computer-readable medium storing instructions executable by the one or more processors 188 to perform operations. The operations can include receiving and/or transmitting signals (e.g., by the transceiver) from and/or to the at least one satellite. The operations can include receiving and/or transmitting (e.g., by the transceiver) data packets containing geolocation data from and/or to the at computer sub-system. The operations can include processing or determining a geolocation based on the received signals form the at least one satellite. the geolocation may be a set of global coordinates (e.g., a longitude and/or latitude). The operations can further include transmitting and/or receiving signals and/or data packets using a Long Range (LoRa) radio module 189 (e.g., RYLR896). The radio module 189 transmits data and/or signals within a range threshold, e.g., a range threshold of about 1 meter (m) to about 15,000 m. The computer sub-system 108 is arranged within the range threshold defined by the radio module 189. While the LoRa radio module 189 has been described, some electronic sub-systems using other types of long range, low power radio modules. The microcontroller 186 and/or processor 188 also includes input/output (I/O) pins 190 for communication and controlling physical objects.

The electronic sub-system 110 includes a power source 192 (e.g., a lithium battery) and a protective module 194 (e.g., BMS, TP4056). The protective module 194 may prevent or reduces the risk of over-charging the battery, over-discharging the power source, and/or short-circuiting the electronic sub-system.

The electronic sub-system 110 also includes a converter 196 (e.g., boost converter, MT3608) The converter 196 is operable to increase a voltage supplied by the power source 192.

FIG. 4D is a perspective view of the uniform, protrusion 118 of the device 102. The protrusion 118 includes the coupling 138 at the connection or attachment end 134 and a body 140 extending from the coupling 138. The body 140 includes a tip 142 at the free end 136 of the protrusion 118. The free end 136 of the protrusion 118 and the housing 106 attach by a snap fit connection. The body 140 defines the opening 144 by an inner edge 198. The body 140 also includes an outer edge 198. The outer edge 198 of the body 140 is a smooth, sharp cutting edge. the tip and/or cutting edge are configured to impale or stab a deposit of scale in a pipeline. The protrusion has a total length ltot (total protrusion length). The body 140 of the protrusion 118 also has a length lb (body length). the protrusion length is about 1 to about 3 inches. The body length is about 8 to about 10 inches.

In some devices, the body length lb is equal the length of the protrusion that extends from the exterior surface of the housing lp. In some devices, the body length lb is less than the length of the protrusion that extends from the exterior surface of the housing lp. In some devices, the body length lb is greater than the length of the protrusion that extends from the exterior surface of the housing lp.

The protrusion 118 also includes the protrusion coupling 138 which releasably fixes the protrusion 118 to the aperture (coupling) 166 of the housing 106. The coupling 138 includes a base 204, a first arm 206 extending from the base, and a second arm 208 extending from the base. The first arm 206 forms a first ledge 210 that abuts the coupling walls 115 of the recess 158 when the protrusion 118 is engaged with the housing 106. The second arm 208 forms a second ledge 212 that abuts the coupling walls 115 of the recess 158 when the protrusion 118 is engaged with the housing 106. The base 204 connects to the body 140 of the protrusion 118. The first and second arms may be flexible or hinged so that the arms fold up when the connection end is inserted into the slot and expand to expose the first and second ledges when the connection end is arranged near or in the closed end of the recess.

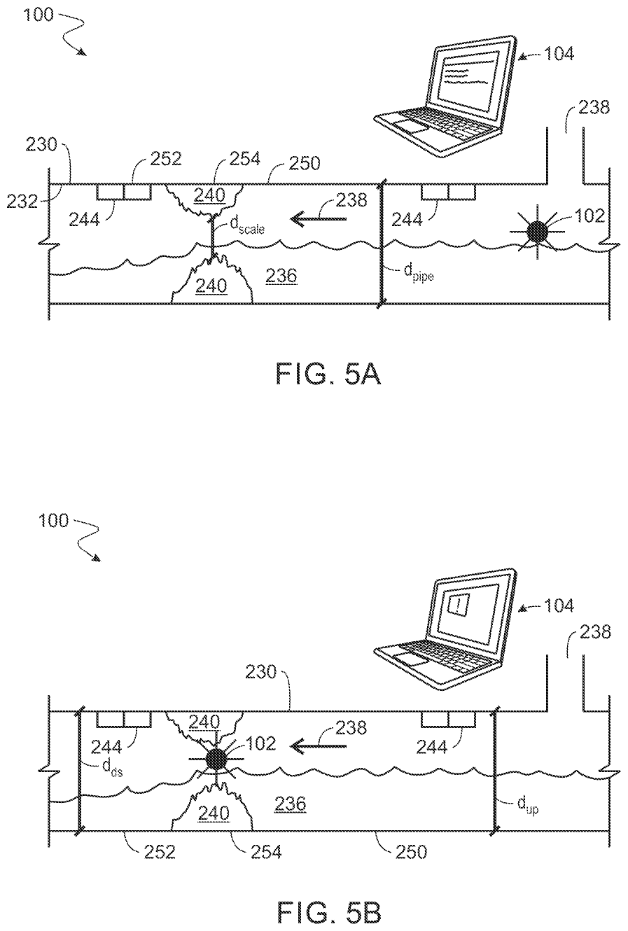

FIGS. 5A and 5B are cross sectional front view of the system 100 for locating a scale deposit in a pipeline 230. The pipeline has a diameter dpipe that is known or determined. The pipeline 230 includes an inner surface 232 which defines an interior volume 234. Fluid 236 flows in the interior volume 234 along a fluid path 238.

Scale 240 (e.g., a scale deposit) has developed on the interior surface 232 of the pipeline 230 and extends into the interior volume 234 of the pipeline 230. The pipeline 230 includes an access channel 242 (e.g., an isolation valve) arranged upstream of the scale deposit 240. The system 100 can also include a sensor arrangement 244 operably connected to the computing sub-system. The sensor arrangement 244 can include at least one of a temperature sensor, a pressure sensor, a flow rate sensor, a scale sensor, a capacity sensor, and a hydrocarbon sensor.

The pipeline has a (first) upstream section 250 arranged upstream of the scale deposit 240 and has a (second) downstream section 252 arranged downstream of the scale deposit 240. The fluid path 238 defined in the interior volume 234 of the pipeline extends at least through the upstream portion 250, the choked portion 254, and the downstream portion 252. The flow path 238 has a maximum cross-sectional diameter in each of these sections. In the upstream section 250, the maximum flow path diameter dup is equal to the pipeline diameter dpipe. In the downstream section 252, the maximum flow path diameter dds is equal to the pipeline diameter dpipe. In the choked section 254, the scale deposit reduces the maximum flow path diameter dscale. As such, the dpipe at the choked section 254 is greater than the maximum flow path diameter dscale. Due to this configuration, the pressure in the upstream section 250 of the pipeline may greater than the pressure in the downstream section 252 of the pipeline. The sensor arrangement may measure various parameters of the interior volume of the pipeline at the upstream section and the downstream section to identify a potential scale deposit area or anomaly.

The sensor arrangement can include a temperature and/or pressure sensor arranged in the upstream portion and a temperature and/or pressure sensor arranged in the downstream portion. The temperature and/or pressure sensors may be operable to measure and transmit a temperature and/or pressure of the interior volume of the pipeline to the computing sub-system. In some cases, the sensor arrangement can include a flow meter in the upstream portion of the pipeline and a flow rate sensor in the downstream portion of the pipeline. The flow rate sensors may be operable to measure and transmit a flow rate of the fluid flowing in the interior volume of the pipeline to the computing sub-system.

To determine the location of a potential or anticipated scale deposit, the device 102 is inserted into the pipeline 230, for example by the access channel 23. The device 102 flows with the flow path 238 of the fluid 236 until reaching the scale deposit 240. The device 102 latches or fastens onto the scale deposit by the protrusions 118. At least one protrusion 118 of the set of protrusions 108 impales or stabs the scale deposit 240 so that the device 102 sticks or latches onto the scale deposit. The engagement between the protrusion and the scale 240 resists any forces applies by the fluid flowing in the flow path to maintain the device 102 in a static pipeline location, fixed to the scale deposit 240.

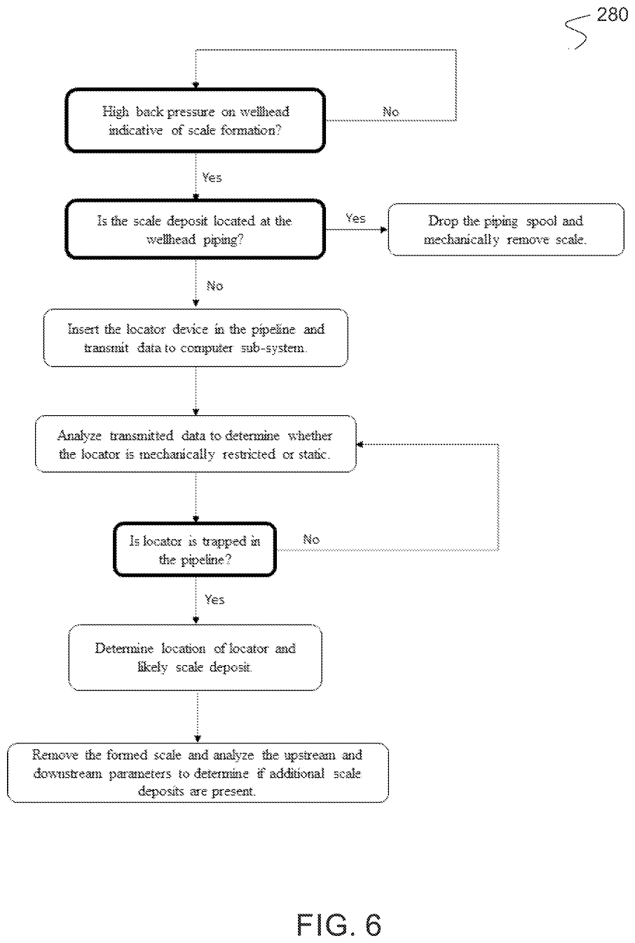

FIG. 6 is a decision flowchart of a method for locating a scale deposit in a pipeline using a system with a locator device and a remote computer sub-system. The method is described with reference to the system 100, however, the method can be used with any applicable system. Initially, the computer sub-system may receive sensor data from the sensor arrangement and determine, based on the sensor data that a scale deposit may have formed in a section of the pipeline. For example, the computer sub-system periodically checks (e.g., by pressure transmitters, pressure gauges) for a high back pressure on the well head potentially caused by scale formation. Upon determining a high back pressure on the well head is or could be the effect of a scale formation in the pipeline, determine whether scale is present that the well head piping. If the scale exists at the wellhead, a piping spool can mechanically remove the scale without use of the locator device.

If scale is not present at the well head piping, or the back pressure exists after removing scale at the well head piping, an operator deploys the locator device to determine where a scale deposit may have formed in the pipeline The computer sub-system or an operator may identify the access channel upstream of the anticipated scale deposit and inserts the locator device into the pipeline via the access channel. the device at least partially floats within the fluid flowing in the pipeline and moves with the fluid in the fluid pipeline through the upstream section of the pipeline.

As the locator device floats through the pipeline, the device periodically communicates with at least one satellite using the GPS module, determines a first geolocation of the device and generates a first set of data (geolocation) packets. The first set of data may include a single geolocation taken in a single period or may include multiple geolocations taken over multiple periods. The device then transmits the first data packets to the computing sub-system using the electronic sub-system. The first data packets include at least the determined first geolocation. While the device moves along the pipeline with the fluid, the geolocation of the device is a variable geolocation. However, if and/or when the device engages the scale deposit, the device remains in a fixed location (e.g., trapped or fixed to the static location of the scale deposit). The geolocation of the device when engaged with the scale deposit is a static geolocation. In the method, the first data packets are (first) variable geolocation data packets. The computing sub-system receives the first data packets and determines a first location of the device based on the first data packet. The first location may be a first longitude and a first latitude.

When the locator reaches the choked section of the pipeline, the protrusions of the device engage or fasten the device to the scale deposit. The device communicates with at least one satellite using the GPS module and determines a second geolocation of the device. The device then generates a second set of data (geolocation) packets. The second set of data may include a single geolocation taken in a single period or may include multiple geolocations taken over multiple periods. The second set of geolocation data includes at least a static geolocation. The device then transmits the second data packets to the computing sub-system using the electronic sub-system of the device.

The computing the second data packets and determines a second location of the device based on the second data packet. The second location may be a second longitude and a second latitude. The computing sub-system then determines if the second location is a static second location. In some systems, the computing sub-system compares the first and second locations to determine if the device is fixed to a scale deposition. If the first and second locations are similar or the same, the computing sub-system determines the location of a scale deposit at least partially based on the second data packet and/or the determined second location of the device. A pipeline location of the scale deposit may also be determined by mapping the scale location to a map of the pipeline systems.

The computer sub-system then generates an alert to on operator via a display. The alert may be a visual alert that displays the determined scale location or estimated scale location relative to the pipeline. Operators may then cut into the pipeline at the scale location and remove the device from the pipeline (e.g., by a hook shaped tool, magnetic tool, or retriever tool inserted into an opening in the pipeline). After removal of the device, with the pipeline is cleaned and/or descaled to remove the built-up scale. In some methods, Subsequently, an examination of the upstream section and/or downstream section of the pipeline is carried out. After cleaning the pipeline, an operator may elect to deploy the device a for another run to locate additional scale deposits and/or to confirm that all the scale in a specific location is removed. The operator may review or analyze the upstream in downstream portions of the pipeline relative to the located scale deposit to determine if additional runs or intervention methods are needed.

FIG. 7A is a front view of a protrusion 300 insertable into the recess 158 of the first and/or second portion 114, 116 of the device 102. The protrusion 300 is substantially similar to the protrusion 118, however, the protrusion 300 includes a body 302 shaped as a spike. The spike 302 extends from the coupling 138 to a pointed, sharp tip 304.

FIG. 7B is a front view of a protrusion 310 insertable into the recess 158 of the first and/or second portion 114, 116 of the device 102. The protrusion 310 is substantially similar to the protrusion 118, however, the protrusion 310 has a body 312 with barbed or serrated edges rather than a cutting edge. The barbed edges include an inner barbed edge 314 and an outer barbed edge 316. The inner barbed edge devices an opening 318.

FIG. 7C is a front view of a protrusion 320 insertable into the recess 158 of the first and/or second portion 114, 116 of the device 102. The protrusion 320 is substantially similar to the protrusion 118, however, the protrusion 320 has body 322 has a (first) tip part 324 at a tip 326 and a (second) root part 328 extending between the first part 324 and the coupling 138. The first part 324 is formed by a (first) tip material and the second part 328 is formed by a (second) root material. The tip material is different from the root material. The tip material may be harder, shaper, more brittle, stiffer, or denser than the root material. In some protrusions, the root material may be harder, shaper, more brittle, stiffer, or denser than the tip material

FIG. 7D is a front view of a protrusion 330 insertable into the recess 158 of the first and/or second portion 114, 116 of the device 102. The protrusion 330 is substantially similar to the protrusion 118, however, the protrusion 330 has body 332 has a (first) outer part 334 and a (second) inner part 335 extending between the outer part 334 and the coupling 138. The outer part 334 is formed by a (first) outer material and the inner part 335 is formed by a (second) inner material. The outer part 334 forms a tip 336 and outer edges 337 of the body 332. The inner part 335 forms an inner edge 338 which defines an opening 339. The outer material is different from the inner material. The outer material may be harder, shaper, more brittle, stiffer, or denser than the inner material. In some protrusions, the inner material may be harder, shaper, more brittle, stiffer, or denser than the outer material

FIG. 7E is a front view of a protrusion 340 insertable into the recess 158 of the first and/or second portion 114, 116 of the device 102. The protrusion 340 is substantially similar to the protrusion 118, however, the protrusion 340 includes a body 342 shaped as a spear. The spear 342 includes tiered, barbed edges 344 extending from a staff 346. The staff 346 is connected or attached to the coupling 138 of the protrusion 340.

FIG. 7F is a front view of a protrusion 350 insertable into the recess 158 of the first and/or second portion 114, 116 of the device 102. The protrusion 350 is substantially similar to the protrusion 118, however, the protrusion 350 has a trident-like body 352. Ahead 353 of the body 352 includes a central spear 354 having a central spearhead 356. The head 353 also includes at least two grapples 358 flanking the central spear 354. Each of the grapples 358 includes a hook strut 360 and a spearhead or hook 362. The head 353 is connected to the coupling 138 by a staff 364.

FIG. 8A is a front view of a protrusion 380 with of coupling 382 for attaching the protrusion 380 to the complimentary coupling (not shown) in a recess in the first and/or second portion 114, 116 of the device 102. The protrusion 380 is substantially similar to the protrusion 118, however, the protrusion 382 has a pressure sensor 384 mounted on the base 204 of the coupling 138. The pressure sensor 384 is operatively coupled to the electronic sub-system of the device and is operable to measure a pressure and/or a change in pressure over time. A device 102 with the protrusions 380 can include pressure measurements in the first and/or second transmitted data packets. The pressure measurement may indicate when the protrusion impacts and/or fastened a scaler deposit. Further, the impact pressure and fastening pressure experienced by the pressure sensor may indicate a type of scale in the scale deposit.

FIG. 8B is a front view of a protrusion 390 with of coupling 392 for attaching the protrusion 390 to a complimentary coupling (not shown) in a recess in the first and/or second portion 114, 116 of the device 102. The protrusion 390 is substantially similar to the protrusion 118, however, the protrusion 390 has a coupling 392 with a base 394 having a threaded surface 396. The recess walls of a housing (not shown) form complimentary threads so that the protrusion may be releasably fixed to the housing by threaded engagement.

In some systems the housing coupling and the protrusion coupling form a snap fit connection. In some systems, the housing coupling and protrusion connect by a magnetic connection, by a ball-in-socket connection and/or by a disc-in-socket connection.

FIG. 8C is a front view of a protrusion 410 with of coupling 412 for attaching the protrusion 410 to a complimentary coupling (not shown) in a recess in the first and/or second portion 114, 116 of the device 102. The protrusion 410 is substantially similar to the protrusion 118, however, the protrusion 410 has the coupling 412 with an insertable base 414 (e.g., a sphere, ball, or disc). The recess walls of a housing (not shown) and/or the closed end of a recess of the housing can include a complimentary housing shape (e.g., a socket) which receives the insert 414 of the protrusion 410. The opening of the recess in the housing has a smaller cross section than the cross section of the insert 414. In this configuration, the protrusion 410 is releasably coupled to the device.

A user or machine may insert and/or remove the protrusion 410 by applying a threshold insertion force and/or a threshold separation force to the protrusion 410 (e.g., pushing towards the housing or pulling away from the housing. The threshold insertion force may be equal to or different (e.g., greater, or smaller) than the separation force. In use, the coupling 412 of the protrusion 410 is inserted into the recess of the housing at a force equal to or greater than the required insertion force to reliably engage the insert 414 with the housing of the device.

FIG. 8D is a front view of a magnetic protrusion 420 with of coupling 422 for attaching the protrusion 420 to a complimentary coupling (not shown) in a recess in the first and/or second portion 114, 116 of the device 102. The protrusion 420 is substantially similar to the protrusion 118, however, the protrusion 420 has the coupling 422 with a base 424 and a (first, protrusion) magnet 426 mounted to or integral with the base 424. The recess walls of a housing (not shown) and/or the closed end of a recess of the housing can include a complimentary housing magnet which attracts the protrusion magnet 426. In use, the coupling 422 of the protrusion 420 is inserted into the recess of the housing so that the protrusion magnet and the housing magnet form a magnetic connection. In some cases, the closed end of the recess is formed by or includes a magnetizable material, a magnetic material, and/or multiple magnets to form a releasable connection between the protrusion 420 and the housing.

In some cases, the closed end of the recess is formed by or includes a magnetizable material, a magnetic material, and/or multiple magnets to form a releasable connection between the magnetic protrusion and the housing. In some devices, the base of the protrusion is formed by or at least partially includes a magnetizable material, a magnetic material, and/or multiple magnets. In such a configuration, the protrusion may not include the magnet.

While releasably connected protrusions have been described, some protrusions are detachable from the housing during use of the device. For example, some protrusions are detachable from the housing while the device is in the pipeline (e.g., upon receiving a signal from the computer sub-system and/or the device). Detachable protrusions may be electronically detachable protrusions, magnetically detachable protrusion, mechanically detachable protrusions, chemically detachable protrusions, or any combination thereof.

A system with a device having detachable protrusions can selectively separate individual protrusions from the housing and/or groups of protrusion from the housing. Controlling the attachment or connection state between protrusion and the housing can allow the device to fix to a scale deposit, then unfix from the scale deposit by detaching the protrusion fixed to a scale deposit (“scale-fixed protrusion”) from the housing of the device. Other protrusions of the device remain attached to the housing (“housing-attached protrusions”) and move with the device even after detaching one or more scale-fixed protrusions. The device is then free to fix to a downstream scale deposit by a “housing attached protrusion” and/or can be collected at a downstream location.

FIG. 8E is a front view of a detachable protrusion 430, the magnet is rotatable relative to the base of the protrusion. The protrusion 430 has the coupling 432 with a base 434 and a (first, protrusion) magnet 436 mounted to or integral with the base 434. The protrusion 430 is substantially similar to the protrusion 420, however, the protrusion 430 includes a rotational subunit 438. The rotation subunit 438 is shown in dashed lines and is operable to move and/or rotate the magnet 436 relative to the base 434. The movement (e.g., rotation) of the magnet misaligns poles of the protrusion magnet 436 and the magnet in the recess of the housing so that a magnetic force repels the protrusion magnet 436 from the magnet in the recess.

The rotational subunit 438 can include a shaft 440 fixed at a (first, base) proximal end to a motor 442 in the base 444. The shaft 440 is also rotationally fixed at a (second, magnet) distal end to the magnet 446. The motor 442 is operable to move the magnet 446 clockwise, counterclockwise, and/or axially by moving and/or rotating the shaft 440. In some cases, the movement of the motor and shaft flip the magnet so that a face of the magnet initially in contact facing the closed end of the recess of the housing contacts or faces the body of the protrusion.

The rotational subunit 448 also includes a signal transceiver, a controller 448 and/or at least one processor, and a power source (e.g., a battery) (not shown). The controller 442 is operable to control the motor 442 and operable to receive signals from a computer sub-system via the signal transceiver. The signal transceiver is operable to receive and transmit signals containing data and/or containing packets of data (e.g., a measurement from a sensor on the body of the protrusion). Upon receiving a signal from the computer sub-system, the controller 448 of the rotation subunit 438 instructs the motor 442 to rotate, and by mechanical connection, the shaft 440 and magnet 436. Rotation of the magnet 436 may align the magnet 436 with the magnet in the housing to generate an attractive magnetic force and/or may misalign the magnet 436 from the magnet in the housing to generate a repellant magnetic force. The attractive magnetic force releasably holds and/or couples the protrusion 430 to the housing. The repellant magnetic force uncouples, repels, detaches, and/or disconnects the protrusion 430 from the housing. When disconnected, the protrusion 430 is separable from the device (e.g., recess of the housing and the housing) such that the device may move (e.g., by fluid in the pipeline) downstream while the protrusion 430 remains fixed the to the scale deposit.

The location sub-system 110 in the housing may send a signal to the computing sub-system 108 containing geolocation data at the time of disconnection (e.g., detachment, separation, or repelling) between the protrusion 430 and the housing. The transmitted geolocation from the device to the computer sub-system includes geolocation data, which indicates or contains the location at which the protrusion 430 attached to a scale deposit. In this configuration, multiple geolocations and/or packets of geolocation data can be transmitted to the computer sub-system while the device remains pipeline on a single scale location run. The device can continue through the pipeline to locate and/or identify other scale deposits when a remaining housing-attached protrusion fixes to a downstream scale deposit. Any scale-fixed protrusion detached from the housing may remain in the scale deposit while separated device moves downstream in the pipeline.

In some cases, the device can confirm or indicate the existence of a large scale deposit because, after an initial detachment of a scale-fixed protrusion, the device may continue through the pipeline and refix to the scale deposit by a different, housing-attached protrusion. The computer sub system can determine and/or receive multiple detachment locations indicating the one or more scale deposits.

A series of detachment locations (e.g., at least two detachment locations) at or within a predetermined distance (e.g., equal to or less than about 1 meter (m), 3 m, 5 m, 10 m, 50 m, 100 m, 250 m 500 m, 1000 m) can indicate a scale deposit and the location of the scale deposit. Some computer sub-systems confirm and/or communicate the location of a scale deposit only after receiving or determining a series of detachment locations equal to or less than the predetermined distance. Some computer, sub-system can estimate or calculate a part of the length or entire of the scale deposit based on the series of detachment locations.

A series of detachment locations (e.g., about two detachment locations) at or outside a predetermined distance (e.g., equal to more than about 0.5 m, 1 m, 3 m, 5 m, 10 m, 50 m, 100 m, 250 m 500 m, 1000 m) at least two detachment locations) can indicate the presence of multiple scale deposits in the pipeline. In some cases, the computer sub-system determines and/or receives multiple detachment locations (e.g., at least two detachment locations) and confirms and/or communicates the multiple detachment locations to a user or other connected system.

While a detachable protrusion 430 has been described with a magnetic coupling 432, some detachable protrusions have a different coupling. For example, in some detachable protrusions, the coupling is a threaded coupling with a threaded portion rotationally attached to a base by a rotational sub-unit (e.g., rotational sub-unit 428).

While multiple couplings have been described, some devices include a combination of couplings. For example, some devices include a snap fit coupling, a magnetic coupling, a detachable coupling with a rotational subunit, a pressure sensor coupling, a ball-in-socket coupling, a disc-in-socket coupling, a male-female coupling, a clamping coupling, a hooked coupling, a Velcro coupling, a clutch coupling, and/or a threaded coupling.

While a variety of couplings have been described as connected to the body 140 or a body substantially similar to the body 140, the couplings may be connected, attached, mounted, fixed, or integral to other bodies, for example, the bodies 302, 312, 322, 332, 342, 352 described with reference to FIGS. 7A-7F.

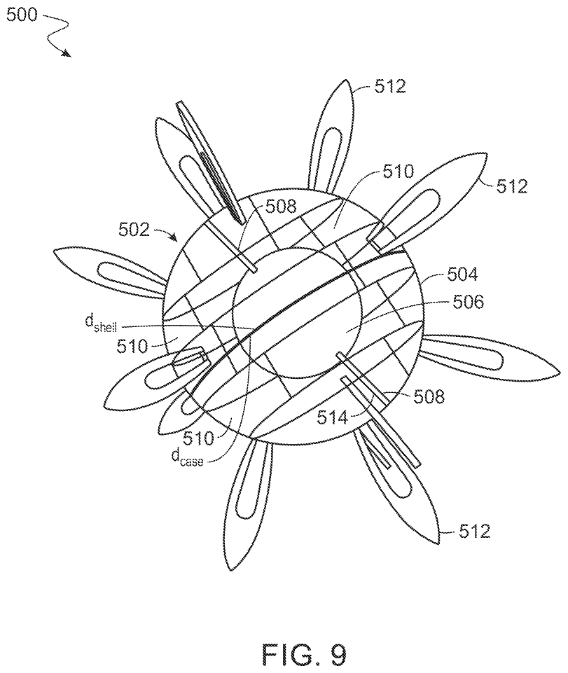

FIG. 9 is a perspective front view of a system 450 with a set of devices having different diameters and permanent blades. The set of devices includes a first device 452 with a first housing 454 having a first diameter d1 and a second device 456 with a second housing 458 having a second diameter d2, larger than the first diameter d1. In some devices, the first and second diameters are equal. In some devices, the first diameter is greater than the second diameter. The first device 452 and second device 456 are substantially similar to the device 102, however, the first and second devices 452, 456 have permanent protrusions 460, 462 that are permanently fixed to the housings 454, 458 of each device 452,456 rather than releasably attached to the housing 106 of the device 102. The protrusions 460 of the first device 452 have a first length l1 that is less that a second length l2 of the protrusions 462 of the second device 456.

FIG. 10 is a perspective front view of a device 500 with a housing 502 having a permeable shell 504 encompassing a protective casing 506 of the device 500. The permeable shell 504 includes beams 508 that interconnect to define openings 510 through which fluid can flow. Protrusions 512 extend from the shell 504. The casing 506 is substantially similar to the housing 502 of the device 500, however, the casing 506 includes poles 514 which connect the casing 506 to the shell 504.

In use, the device 500 flows through the pipeline 230 (FIG. 5A) and impales or fastens to a scale deposit 240 (FIG. 5A) in the pipeline 230 (FIG. 5A). The shell 504 allows fluid to flow through and around the openings 510 of the device 500 so that production operations can continue while locating the scale deposit 240 (FIG. 5A).

FIGS. 11A and 11B are perspective views of a device 550 with retractable blades 552 in a retracted position and an extended position, respectively. The device 550 can include a motor (not shown) and/or gears (not shown) for extending and/or retracting the blades 552. In use, the device 550 is inserted into a pipeline 230 (FIG. 5A) in the extended position and attaches to a scale deposit 240 (FIG. 5A) in the extended position. Once the location is determined, the device 550 can disengage the scale deposit 240 (FIG. 5A) by retracting the blades 552 into recesses 554 of a housing 556.

In the retracted position, the protrusions 552 have a length lr and the housing has a housing diameter dh. In the extended position, the protrusions 552 have a length le. the extended length le is greater than the restricted length lr.

A number of embodiments have been described. Nevertheless, it will be understood that various modifications may be made without departing from the spirit and scope of the disclosure. Accordingly, other embodiments are within the scope of the following claims.

What is claimed is:

1. A system comprising:
a locator device comprising:
a hollow, housing comprising:
an interior cavity,
an exterior surface defining at least one slot, and
at least one recess extending from the at least one slot of the exterior surface of the housing, towards the interior cavity of the housing;
an electronic sub-system arranged in the interior cavity of the housing, the electronic sub-system comprising:
a global position system (GPS) module operable to determine a geolocation of the device; and
a transceiver operable to send and receive signals;
at least one protrusion attached to the housing, wherein the at least one protrusion comprises:
a coupling at a first end of the protrusion, wherein the coupling is arranged in the recess of the housing, and
a body having a tip at a second end of the protrusion; and
a computer sub-system operably connected to the electronic sub-system of the device, the computer sub-system comprising:
a controller; and
one or more processors, a non-transitory computer-readable medium storing instructions executable by the one or more processors to perform operations, the operations comprising:
determining a location of a scale deposit in a pipeline based on a received geolocation of the device.

2. The system according to claim 1, wherein the housing further comprises a first portion having a first well and a second portion having a second well, wherein the first and second well define the interior cavity.

3. The system according to claim 2, wherein the first portion comprises a first material, wherein the second portion comprises a second material.

4. The system according to claim 2, wherein the housing comprises coupling walls defining the recess.

5. The system according to claim 4, wherein the coupling walls releasably attach the at least one protrusion to the housing of the device.

6. The system according to claim 1, wherein the housing is a spherical housing.

7. The system according to claim 6, wherein the housing has a diameter of about 0.1 inch to about 4 inches.

8. The system according to claim 6, wherein the device has a diameter of about 1 inch to about 10 inches and comprises a non-metallic material.

9. The system according to claim 1, wherein protrusion is releasably attached to the housing.

10. The system according to claim 1, wherein the body of the protrusion is configured to fasten the device to a scale deposit in a pipeline.

11. The system according to claim 1, wherein the body of the protrusion is a cutting blade having a cutting edge.

12. The system according to claim 1, wherein the body of the protrusion is a serrated blade having a serrated cutting edge.

13. The system according to claim 1, wherein the body of the protrusion comprises multiple barbs.

14. The system according to claim 1, wherein the body of the protrusion defines an opening.

15. The system according to claim 1, wherein the coupling of the protrusion comprises arms engageable with walls of the housing to hold the coupling of the protrusion in the recess of the housing.

16. The system according to claim 1, wherein the body at least partially extends from the exterior surface of the housing.

17. The system according to claim 16, wherein a length of the body extends from the exterior surface of the housing.

18. A method comprising:
fastening to a scale deposit in a pipeline by a body of a protrusion of a device moving within the pipeline;
determining, by a GPS module of the device, a geolocation of the device; and
transmitting, by a transceiver of the device, the geolocation of the device to a remote computer sub-system.

19. The method according to claim 18, wherein fastening to the scale deposit in the pipeline comprises impaling the scale deposit with a blade of the body.

20. The method according to claim 18, wherein fastening to the scale deposit in the pipeline comprises catching onto a surface of the scale deposit by a face of the body.

21. The method according to claim 20, wherein the face of the body is serrated.

22. The method according to claim 20, wherein the face of the body is barbed.

23. The method according to claim 20, wherein the face of the body is spiked or spined.

24. The method according to claim 18, wherein transmitting, by the transceiver of the device, the geolocation of the device to the remote computer sub-system comprises:
determining, by a pressure sensor of the protrusion, a pressure from contact between the body and the scale forming the scale deposit, and
in response to the pressure, activating the GPS module.

25. The method according to claim 18, wherein the geolocation is a static geolocation, and wherein the method further comprises:
prior to fastening to the scale deposit, determining, by a GPS module in the device, a variable geolocation of the device; and
transmitting, by the transceiver of the device, the variable geolocation of the device to the remote computer sub-system.

26. A method comprising:
receiving a first set of geolocation data from a device in a pipeline;
receiving a second set of geolocation data from the device in the pipeline;
determining if the device is static in the pipeline based on at least the first set of geolocation data and the second set of geolocation data; and
in response to determining the device is static, determining static coordinates of the device based on at least the second set of data.

27. The method according to claim 26, wherein the coordinates contain a longitude and a latitude.

28. The method according to claim 26, further comprising generating an alert on a display of the computer sub-system or connected to the computer sub-system, wherein the alert displays the static coordinates of the device in the pipeline.

29. The method according to claim 26, further comprising:
prior to receiving the first set of data, receiving measurement parameter of a pipeline, wherein the parameter is at least one of:
a pipeline pressure and a flow rate of fluid in the pipeline; and
determining that the parameter suggests scale formation in a portion of the pipeline.

30. A locator device comprising:
a hollow housing having a housing diameter, the housing comprising:
an interior cavity,
an exterior surface defining at least one slot, and
at least one recess extending from the at least one slot of the exterior surface of the housing, towards the interior cavity of the housing;
an electronic sub-system arranged in the interior cavity of the housing, the electronic sub-system comprising:
a global position system (GPS) module operable to determine a geolocation of the device; and
a transceiver operable to send and receive the geolocation of the device,
at least one protrusion releasably attached to the housing, wherein the at least one protrusion comprises:
a coupling at a first end of the protrusion, wherein the coupling is arranged in the recess of the housing, and
a body having a tip at a second end of the protrusion, wherein the body is configured to fasten the device to a scale deposit.
